(19) United States
(12) Patent Application Publication
(10) Pub. No.: US 2010/0299370 A1
(43) Pub. Date: Nov. 25, 2010

(54) METHOD AND APPARATUS FOR COMBINING A FIRST PARTITION FROM A FIRST DIGITAL MAP DATABASE AND A SECOND PARTITION FROM A SECOND DIGITAL MAP DATABASE

(76) Inventor: Hans Ulrich Otto, Hildesheim (DE)

Correspondence Address: Harness, Dickey & Pierce P.L.C., P.O. Box 8910, Reston, VA, 20195, US

(21) Appl. No.: 12/734,672

(22) PCT Filed: Dec. 28, 2007
(86) PCT No.: PCT/EP2007/064614

§ 371 Date: Jul. 20, 2010

(51) Int. Cl. G06F 17/30

(52) U.S. Cl. 707/803; 707/E17.005

(57) ABSTRACT

A method is disclosed for combining a first partition from a first digital map database and a second partition from a second digital map database, wherein the first and second digital map database are associated with a coordinate reference system, wherein the first and second partition include an interaction with each other in a common region in the first and second digital map database. In at least one embodiment, the method includes identifying a first group of objects in the first partition from the first digital map database, wherein each object includes a position within said common region; encoding the objects of the first group with a first group of location references; decoding the first group of location references on the second partition from the second digital map database; identifying the location references of the first group that could successfully decode on the second partition to determine topological connections; and, combining the first partition with the second partition in the second map database in dependence of the location references associated with the topological connections.

### FIELD OF THE INVENTION

The present invention relates to a method of combining a first partition from a first digital map database and a second partition from a second digital map. The invention further relates to an apparatus for combining a first partition from a first digital map database and a second partition from a second digital map database.

### PRIOR ART

Historically, maps were printed on paper or other non-modifiable, non-interactive media, and did not allow any user modification of the information or of relationships between data points. Moreover, documents could not be updated when new information appeared, and the databases in the modern sense of the word did not even exist, rendering the concept of updating them moot.

Prior to the computer age, there were essentially two forms of recourse when a map needed modification: 1) to enter a modification by hand on the paper copy; or 2) to reprint the map with the modification made on the original. A modification could be a correction of errors in the map, an addition of new features, such as new road, buildings, etc, or removal of obsolete features. Manual modifications are time-intensive, particularly for multiple modifications, and by definition do not update any of the other outstanding copies of the map. The option of reprinting the map is expensive and also an impractical way to respond to frequent modifications.

In the current age, we have databases, documents, and maps in digital, electronic formats, capable of being updated as desired and able to respond to a selected range and type of operator input and to produce operator-requested output. Many electronic documents and electronic databases in common usage today comprise information related to geographic location(s). Indeed, it is not necessarily easy to think of a class of electronic documents or a class of electronic databases that does not at least occasionally incorporate some form of geographically related information.

Current technology allows to store geographic maps in computer systems. A geographic map being stored in a computer system will be referred to as digital map or digital map databases. The content of a digital map can be described as objects having a specific location in space. The location of an object in a digital map is usually described by means of a coordinate reference system, being a mathematical model referring to the x and y axis in space. Additionally such an object carries attributes describing the object in terms of a name and other specific features. The union of attributes and location are an object in a digital map.

Digital maps are produced for a wide range of applications. Standardisation efforts of digital maps have been limited to data models for specific applications, such as the GDF data model which is a CEN standard developed for and used in traffic and telematics applications. Various organisations produce digital maps according to the GDF standard. However, there are some variations with respect to the level of detail and the content actually being captured. This results in the inevitable fact that even though digital maps are according to GDF they can/do slightly differ depending on the producing organisation. Most in-vehicle navigation systems use digital maps which have been captured according to GDF 3.0.

One example of electronic databases that is relevant to certain embodiments of the invention is geospatial databases, known for convenience and intuitive comprehensibility as electronic maps or digital map databases. In the current computer age, maps have evolved well beyond their centuries-old status as static paper depictions of a non-adjustable data set as recorded at one particular time. For simplicity, much of the discussion below refers to electronic maps, although the points made also apply to electronic documents and electronic databases other than maps that contain geographic information. In this application, the term digital map database is used to denote all kinds of electronic and digital maps.

One of the great benefits of a digital map database over a traditional paper-based map is its inherent flexibility and ability to portray large amounts of data. Paper maps are necessarily limited in the amount and type of information they can portray, within the constraints of their physical formats. Paper maps are also difficult to update.

Digital map databases do not suffer from these problems. While earlier map renderings from digital map databases may have seemed merely like a scanned version of the paper product, today's modern digital map databases are much more powerful. Information can be included in the map and either displayed, or not displayed, depending on the wishes of the operator or the implemented features of a software application.

Today's digital map databases can allow for regular modification of data points included in the map as well as active operator selection of desired geographic features of interest. As new information arises, of a type specifically relevant to a map of interest or a point of interest in the map, the map can be quickly updated to reflect changes or corrections to all or just a small subset of locations.

An important feature of digital map databases is that digital map databases can easily be modified, i.e. by changing existing data or adding new data. For instance, third party information (e.g., a database comprising list of hotels with locations of the hotels) can be added to the digital map database. In order to do this, the third party information needs to be linked to the digital map database, i.e. for any given third party information or data the corresponding location as well as related spatial object(s) in the digital map database are identified. This process is called location referencing.

A simple known location referencing scheme uses coordinates of the digital map database to reference to a location within a digital map database. This is a relatively straightforward, compact and flexible way of referencing to any kind of location and database. However, it is also unreliable and ambiguous, because it only works between maps with substantially the same geometry with respect to absolute and relative accuracy in a coordinate reference system.

EP 0798540 A1 describes a method for referencing fixed objects. Nodes with a grid structure are coded. With a reversible algorithm the nodes can be converted into a geographical coordinate system.

U.S. Pat. No. 5,107,433 describes a method for inputting starting and destination points into a navigation system. Data of street maps comprise a street identification character and reference point coordinates. In a data storage inputted data is searched. When there is a match, the coordinates are taken over for navigation.

Another method of location reference has been developed by the ERTICO Committee on Location Referencing. The proposed method is called “Detailed Location Referencing (DLR) based on Intersection Location (ILOC)”. Intersections in road networks are considered as the basic elements of reference. An ILOC is defined as an intersection identified by its centre coordinates and the first 5 characters names or road numbers of three of the intersecting roads. Every reference made is limited to the road network, which can be described by a single ILOC or combinations of ILOCs. Reference to other objects in a digital map is not possible.

EP1078346 describes a method for generating a location reference instance within a digital map which allows a more efficient and universal form of referencing. The method for location referencing uses an algorithmic approach using only a database with information from the map provider. For example, the popular AGORA method uses several map properties to create a robust reference code, e.g. one or more coordinates, object names and classifications, topology between objects etc. This is a flexible method (although known methods are only proven for point objects and road network).

When comparing a digital map from vendor A with one from vendor B, even if they are built according to the same capturing rules (e.g. GDF), differences for precisely the same object can be noticed:

An object referring to the same geographic phenomena in reality may have different coordinates in different maps. The location of an object, i.e. its position, is described with co-ordinates. These coordinates are assigned to the object in the digitisation process. Digitisation can be done on the basis of a wide range of different sources such as satellite images, aerial photographs, topographic paper maps or cadastral paper maps. Locations can be found by digitisation from images and other data from mobile mapping sensors that carry along position determination devices as well. Since the accuracy and resolution, i.e. the level of detail, of certain geographic phenomena differs with regard to the source used, the same object may be located at slightly different positions depending on the source used.

An object referring to the same geographic phenomena in reality may have different representations (different data models) in different digital maps. Even the GDF data model allows for variations on the representation of objects. Location Referencing Methods (LRM, methods of referencing object instances) differ by applications, by the data model used to create the database, or by the enforced object referencing imposed by the specific mapping system used to create and store the database. A standard Location Referencing Method allows for a common and unambiguous identification of object instances representing the same geographic phenomena in different geographic databases produced by different vendors, for varied applications, and operating on multiple hardware/software platforms.

There is a need to combine digital maps from different map supplier companies to obtain a new map which is a combination of content of these different maps. The European car industry is working on a standard navigation format. A scenario is to have a “patch-work” map for Europe, where they mix regions e.g. countries from the different digital map providers, depending on the local map quality. This is a very challenging task. As to date it requires a huge amount of manual labour work, to fix the broken topology between the patch work pieces, and to fix geometry deviations in the respective maps where they may interact.

The idea is to divide the total mapped area into partitions along boundaries defined by a common coordinate reference system. Then if it becomes desirable to update one or more partitions of the map, say, because the new partition is judged to be more accurate or more current etc., this new partition can be substituted for an old partition and integrated into the user's map. The goal is to be able to produce such a “patch-work” map regardless of what map vendor is providing the new, improved partition.

However, a problem currently exists in this approach. The different representations and different coordinates in different digital maps is an obstacle to replace, in a straight forward method the content of different digital maps. When replacing the contents of a partition from different maps, positional offsets (sometimes quite significant) may occur, resulting in discontinuities in the combined map.

### SUMMARY OF THE INVENTION

The present invention seeks to provide a method of combining a first partition from a first digital map database and a second partition from a second digital map database, wherein the first and second digital map database being associated with a coordinate reference system, wherein the first and second partition having an interaction with each other in a common region in the first and second digital map database.

According to the invention, the method comprises:

identifying a first group of objects in said first partition from said first digital map database, wherein each object comprises a position within said common region;

encoding the objects of the first group with a first group of location references;

decoding the first group of location references on the second partition from the second digital map database;

identifying the location references of the first group that could successfully decode on the second partition to determine topological connections; and,

combining the first partition with the second partition in the second map database in dependence of the location references associated with the topological connections.

The invention is based on the recognition that a multitude of digital map databases are available. The digital map databases are produced from different sources and generated by different tools, by applying different quality rules etc. This could result in relative and/or absolute position inaccuracies, wherein the same object could e.g. be 0.01-60 meters away in the coordinate reference system associated with the databases. Furthermore, the content of a database could have been generated from sources that have been captured over a relatively long time period. This results in a digital map database having regions which are more up-to-date then other regions. Furthermore, regions within a digital map database could have different quality ratings. The quality ratings of each region in a digital map database can be determined. For example, a quality rating can be defined as a function of the relative of absolute positional accuracy of objects in the database, the number of real world features correctly present in the database, capturing date of source data from which the content is derived, the capturing rules, currentness, and any useful combination. This enables us to identify which regions of a first database have a lower quality then the same region in a second database.

It is an object of the invention to provide a method which enables a computer program to replace the content of the partition of the region with the lower quality with the corresponding partition of said region with the higher quality. In this way a “patch-work” map is generated, which is for example a mix of regions e.g. squared areas in a coordinate reference system from map provider 1 and map provider 2 depending on the local quality. It is a further object of the invention to combine the two digital map databases in the coordinate reference system in such a way that rules of topology are preserved.

The method according to the invention is based on the assumption that two partitions from different map databases to be combined, interact with each other within the context of a common coordinate reference system. This means that in the coordinate reference system both maps may be partitioned by applying the same partitioning rules and the partitions can be seen as pieces of a puzzle. Consequently, the overlapping parts of the two databases will be partitioned in the same way, resulting in partitions that could be interchanged from one database to another database. Due to the different positional accuracy of the digital map databases, an object in the first database could have a different position in the coordinate reference system then the same object represented in the second database. Therefore it is further assumed that at the location in the coordinate reference system where the partitions come together, the databases have a common region. The common region is the area containing and neighboring the common partitioning line of the two partitions to be combined, that is present in both databases, and containing the same real world objects to determine the spatial relationship between the partitions. The common region can be seen as for example, a border region of a county. For arbitrary partitioning, the common region may simply be a distance on at least one side of the partition line, and running the length of the partition. When an object has different positions in the coordinate reference system in both databases, this assumption enables the application to detect an object located in the common region present in the first database in the second database and an object located in the common region in the second database in the first database. A location reference is generated for an object in the common region. A location reference according to the invention comprises at least one position with reference to a coordinate reference system and associated attributes to provide a unique description of the object to enable matching with the same object in another database. An attribute may be a symbolic description of a position. Subsequently the location reference is used to find the corresponding object in the other database. Then the position in the coordinate reference system of the object in both databases is used to combine both partitions in a suitable way.

### SHORT DESCRIPTION OF DRAWINGS

The present invention will be discussed in more detail below, using a number of exemplary embodiments, with reference to the attached drawings, in which

FIG. 1 shows a flow diagram of an embodiment of the invention;

FIG. 2 shows the content of a first digital map;

FIG. 3 shows the content of a second digital map;

FIG. 4 shows the content of the combination of a partition of the first and second digital map shown in FIG. 3 and FIG. 4; and,

FIG. 5 is a block diagram of an exemplar computer system for implementing the method according to the invention;

### DETAILED DESCRIPTION OF EXEMPLARY EMBODIMENTS

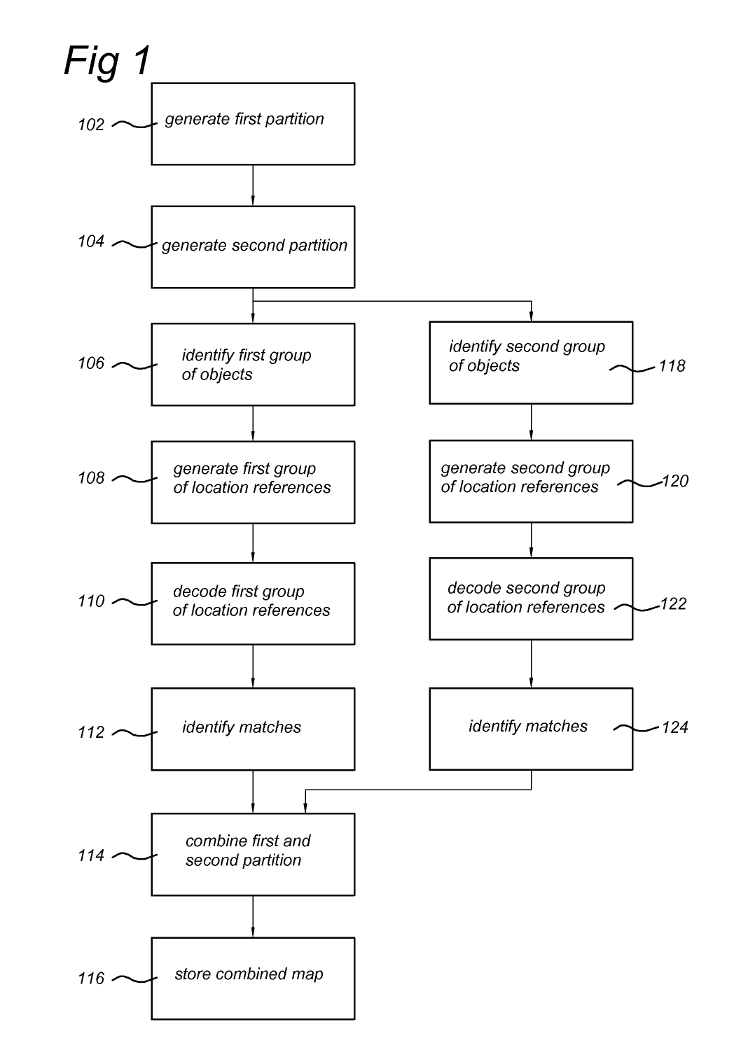

FIG. 1 shows a flow diagram of an embodiment of the invention. The flow diagram shows what actions may be performed for combining the content of two digital map databases. In a first action 102, a first digital map database is segmented in partitions. The partitioning is preferably based on a predefined partitioning scheme. The partitioning scheme is in an embodiment based on a regular grid projected on the coordinate reference system. For example the digital map database could be partitioned into squared regions of 1 km. In another embodiment the partitioning scheme is based on other characteristics present in the database, for example political, town boundary, municipal boundary, local authority boundary, district boundary, county limit, or any other suitable or arbitrary segmentation rule.

In action 104, the second digital map database is segmented into partitions. In this action preferably the same partitioning scheme is used. This ensures that the similar pieces are generated, which enables us to combine partitions from different databases to obtain a new database which can be seen as a “patch work” of partitions of the respective databases.

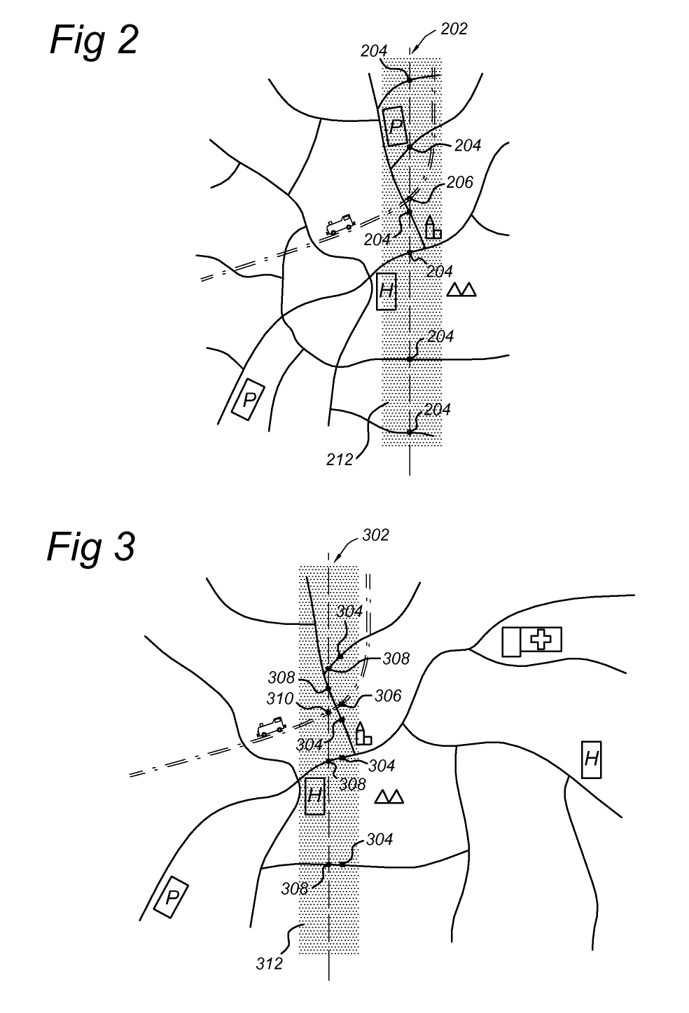

The following actions 106-124 will describe the key of the invention. Key of the invention is to combine partitions from different suppliers or different versions from the same supplier based on topological connections between said partitions. The actions 106-124 describe how to match the topology of two neighboring pieces of the “patch work” map. The actions will be described by means of the FIGS. 2-4.

Which partitions of the digital maps will be combined to obtain the “patch work” digital map depend on the used selection process. The selection process may be based on characteristics associated with each partition, and may be performed automatically or by a user. By means of the selection process, a set of interacting partitions will be selected from similar partitions of both databases. Preferably, the partitions having the best characteristic is selected. The best characteristic could be any distinctive feature selected from the group comprising: quality, currentness, absolute position accuracy, relative position accuracy, completeness, correctness, included (new) features.

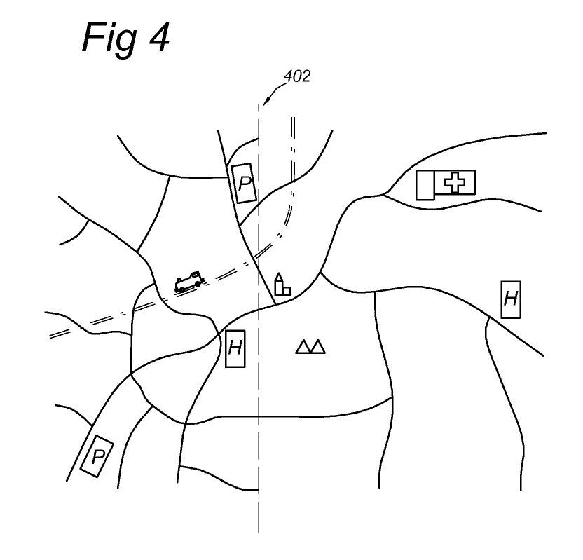

FIG. 2 shows a part of the content of a first database. The dashed vertical line 202 indicates the border line between two partitions. The border line is based on a predefined grid on the coordinate reference system. FIG. 2 shows the topology of a road network, a railway and some map features, such as a parking place, church and hotel. Similarly, shows FIG. 3 the same area mapped on the same coordinate reference system but from a different map vendor. The dashed vertical line 302 corresponds to the same position in the coordinate reference system as used in FIG. 2. However, due to a different data source and map production method, the position of the objects in the digital map has an offset with respect to the position in FIG. 2. FIG. 4 shows the combination of the map at the left hand side of the dashed line in FIG. 2 and the map at the right hand side of the dashed line in FIG. 3 after the application of the invention. It should be noted that the coordinates from the first database have been used as reference positional data. Therefore, dashed line 402 has the same position with respect to the left hand side topology from partitioning line 202 shown in FIG. 2.

In action 106, a first group of objects in a first partition from a first digital map database are identified. The objects have preferably a position at or near the partitioning line forming an edge of a partition. A need is to connect the topology of these objects to the counterpart of these objects in neighboring partitions. Therefore objects crossing the partition's edge are preferably selected. Objects crossing the edge of a partition could be one of a group consisting of road, ferry, railway, walkway, public transport crossing the border of a partition, city limit, county limit, state, country border, border of a specific region e.g. nature reserve or country estate, road segment. However also objects not positioned on or crossing the edge of a partition could be used to find the corresponding object in the two databases in order to find the topological connection between two neighboring partitions with respect to each other. Examples of such objects are: road segment, junction, building, landmark or any other object in a common region of the two databases containing and neighboring the interacting edges of two partitions to be stitched. The common region is the region that is present in both databases containing and neighboring the partitioning line. The common region could be defined as the region including at least the set of real world objects existing in both databases within a distance on at least one side of the partition line, and running the length of the partition line. In FIGS. 2 and 3 the common region is identified with reference numeral 212 and 312 respectively. A characteristic of the common region in both databases may be that they correspond, at least in part, to the same area in the coordinate reference system.

It should be noted that if the partitioning is based on the coordinate reference system, the area in the coordinate reference system of the common region in the first database is equivalent to the common region in the second database. However, due to positional inaccuracies of objects, a real world object within the common region along a partition line in the first database might be outside the common region along the corresponding partition line in the second database.

To be able to match the edges or to find topology connections across the edges of two neighboring partitions, the objects should be present in both databases. If the positions of the objects in both databases correspond to their real positions in the coordinated reference system with infinite accuracy, only the objects exactly on the edge will be present in both partitions. However, as said before, if the partitions are from different databases, the positions of the same object in the two databases will differ depending on the source and absolute and relative positional accuracy. Consequently, an object at the edge of a first partition from a first database may or may not be present in the second partition from a second database which depends on the direction of the offset in position in the coordinate reference system. This means that the area in the coordinate reference system of the network topology of the two partitions to be combined should have at least one spatial relationship selected from the group consisting of: touch, within, overlap, cross, intersect or be disjoint. According to the invention, location referencing is used to find an object taken from the first database, in the second database. By means of location referencing, one has to describe a geographic phenomena as an object in a digital map and check/present the object representing the same geographic phenomena in another digital map. A location reference is a label which is assigned to a location. With a single location reference method (LRM), one reference must define unambiguously and exactly one location in the location referencing system. The location reference is the string of data which is passed between different implementations of a location referencing system to identify the location. A location reference according to the invention comprises at least one position with reference to a coordinate reference system and associated attributes to provide a unique description of the object to enable matching with the same object in another database. An associated attribute could be any symbolic description of a position, area or real world object. For example, the location of a road crossing the partitioning line may be defined by its position along the line and the position of at least the beginning and the ending of the road segment. The beginning and ending of the road have relative positions with respect to each other and the crossing location. These relative positions could describe uniquely the road in a predefined radius. If not, additional positions of neighboring objects are needed to describe the location uniquely by means of its geographic phenomena. In another example, a position on a road segment, is unambiguously described by its position and direction in the coordinate reference space. The LRM determines the amount of positions in a location reference to describe uniquely a location. International standard ISO/DIS 17572 describes coding guidelines for dynamic location references. The existence of an object in a digital map depends on the capturing rules being applied. The accuracy of an object location depends on the capturing process and sources used. This implies that if a location shall be referenced the location reference comprises the position of the object and if necessary attributes to describe the object uniquely in terms of additional positions and attributes of one or more neighboring objects. The location reference describes a geographic phenomena associated with the location of the object.

The location reference enables us to determine the interaction between the first partition from the first digital map database and the second partition from the second digital map database. The interaction could correspond to a spatial relationship selected from the group consisting of: touches, within, overlaps, crosses, intersects, equals, connects with, and disjoint.

During decoding a location reference, the position is used to define a search area around the position in a digital map and the geographic phenomena described by the location reference grants an unambiguous solution to detect the object corresponding to the location reference in the search area defined in the digital map database. Therefore, an area is needed to describe an object by means of a location reference. A region in the coordinate reference system containing and neighboring a partitioning line in both databases has to be present to generate a suitable location reference. In the present application, this region is defined as a common region. The common region should be broad enough to describe accurately the geographic phenomena of each object in the respective databases, otherwise it will not be possible to match the location reference of an object generated from a first database with the corresponding object in a second database. The common region should provide enough context information so that a unique location reference can be generated and decoded. The common region is the region that is present in both databases containing and neighboring the partitioning line. It should be noted, that a location reference for an object in a partition could comprise one or more references to positions outside said partition.

In FIG. 2 six positions 204 where a road crosses the partitioning line 202 and one position 206 where a railway crosses the partitioning line 202 are identified as objects. It should be noted that according to the invention any object in the common region for which a location reference can be generated could be used. Therefore, instead of the positions 204 and 206, the corresponding road segment could be identified as an object.

In action 108 for each of the selected objects on or neighboring the partitioning line 202 a location reference is generated. In FIGS. 2 and 3 only the locations of the crossings are selected. It should be noted, that also the corresponding road segments could be selected as objects. How to encode a location reference for an object is common technical knowledge for one skilled in the art. International standard ISO/DIS 17572-3 provides guidelines for coding location references. Unpublished international patent application PCT/NL2006/050185 describes another suitable method of encoding and decoding location references.

In action 110, the location references generated by the previous action are decoded into data structures of the second digital map database. This is a technology commonly known to one skilled in the art. It should be noted that for each digital map database an encoder for generating location references and a decoder for generating a data structure for an object has to be made available.

In action 112, the data structure corresponding to the location reference is interpreted in order to verify the presence of the object corresponding to the location reference representing the same geographic phenomena as intended by the encoder of the location reference in the second digital map database. The object that matches will be used to link the topology in the first database with the topology in the second database. In FIG. 3, the objects from FIG. 2 that matches have been indicated by a references 304, 306. Four points with reference sign 304 indicate the road crossings that match and reference sign 306 indicates the railway crossing that matches. It can be seen that two border objects in FIG. 2 could not be matched as said roads are not present in the second digital map database. The identified location references from the first database that could successfully decode on the second partition determine the topological connections between the first and second partition. It can be seen that the positions of the identified object are not on the partitioning line 304. This means that the positions in the coordinate reference system of the object in the first and second digital map database differ. The identified objects have almost the same perpendicular distance from the dashed line 302. This is an indication that the positions in the first and second digital map have an offset in the coordinate reference system. It should be noted that normally by combining two partitions from two different database the offset of the positions of objects will vary due to relative accuracy. Therefore, the example of the two partitions shown in FIGS. 2 and 3 wherein all objects have a similar displacement is only given to provide an apparent example on how two partitions wherein objects have different positions in the coordinate reference system can be combined. The offsets or positions in the coordinate reference system of the matched objects in both databases may be used to determine how the position of the object has to be calculated. How to determine the final position of an object in the final database can be done in various ways known to a person skilled in the art and will therefore not be disclosed in detail.

Key of the invention is how to find topological connections between two adjoining partitions, wherein the shared boundary is close to each other in a coordinate reference system. The term “close” means that along the shared boundary an area can be determined in both databases which corresponds to equivalent areas in the coordinate reference system. The common area is used to determine the spatial relationship in the coordinate reference system between the adjoining partitions. The object is to find similar objects in the common region determined for both databases. The objects in the common region present in both databases are used to stitch the two adjoining partitions together. Location referencing is used to describe the objects and to find the same object in the corresponding database.

In action 114, the first partition from the first digital map database and the second partition from the second digital map database are combined in dependence of the location references associated with the topological connections. Both digital map databases comprises a topology which defines the spatial relationships between features. The fundamental components of the spatial data in the database are points, lines (arcs), and polygons. The matched objects define the topological connections between the topology of two interacting partitions. The pointers and ID's in the database associated with the matched objects have to be updated to establish that the right pointers and ID's of the partitions are set so that the two interacting partitions form one new topology in the combined digital map database. If a new partition replaces a corresponding partition in a digital database map, the new partition in the new (updated) digital map database should have substantially the same connectivity as the corresponding partition in the old digital map.

Next to preserving and restoring the topological connectivity when combining partitions from different databases, the spatial relationships in the coordinate reference system have to be updated. As the position of the same object in the different digital map databases could differ, one has to determine a new position in the combined map for said object.

In a first embodiment of action 114, the position in the combined map is the middle between the position of an object in the first digital map database and the position of said object in the second digital map database. This corresponds to averaging the positions of the object in both databases. In this embodiment only the positions of matched objects have to be calculated. The topology of the two partitions will be coupled by for example adding to a record of matched object in the first database a pointer to the record of the corresponding matched object from the second database as known to a person skilled in the art. The other objects in the digital map databases will have their original position in the coordinate reference system.

Instead of averaging the positions of a road crossing the partition line, the road segment corresponding to said position could be determined in both databases. Subsequently, an end of said segment present in the first partition is topologically connected by means of a road database structure to the other end of said segment present in the second partition. In this way, no average position has to be calculated and only the topological description and corresponding spatial relationship of said road segment has to be defined in terms of the new topological connection between the two ends of said road segment.

In a second embodiment of action 114, offsets in position in the coordinate reference system of the positions in the first digital map and the second digital map of the objects associated with the topological connections is calculated. The respective offsets will be analyzed. One skilled in the art is able to determine from the offsets and corresponding position in the coordinate reference a spatial relationship between the position of the objects in the first and second digital map. The spatial relationship defines how a position in the first digital map has to be converted into a position in the second digital map. The conversion can be a translation, rotation, scaling or any combination of said operations. The conversion, which is a positional adjustment of positions in a database to obtain a new position in another database, is subsequently applied to the positional information in one of the databases. The conversion can be expressed as a translation, rotation and scaling vector for each object in the database which depend on the relative position in the partition. For example, if the matched topological connections all have a similar positional offset in the databases, an average offset could be determined. Subsequently, the average offset could be used as translation vector, which can be regarded as a positional adjustment, to calculate the new coordinates for the objects from the second database when combined with the content of the first database. As with the first embodiment, the topology of the two partitions will be coupled.

In another example, an average position in the coordinate reference system from the position of an object associated with a topological connection in the first digital map and the second digital map is calculated. When combining the first and second partition, the average position to the object associated with the topological connection is assigned to the object in the combined digital map.

In a third embodiment of action 114, rubber sheeting is performed by means of the objects associated with the topological connections to obtain a combined digital map. In cartography, rubber-sheeting refers to the process by which a layer is distorted to allow it to be seamlessly joined to an adjacent geographic layer of matching imagery, such as satellite imagery (most commonly vector cartographic data) which are digital maps. This is sometimes referred to as image-to-vector conflation. Often this has to be done when layers created from adjacent map sheets are joined together. Rubber-sheeting is necessary because the imagery and the vector data will rarely match up correctly due to various reasons, such as the angle that the image was taken at, the curvature of the surface of the earth, minor movements in the imaging platform (such as a satellite or aircraft), and other errors in the imagery. There are other methods known to one skilled in the art of transforming the geometry to smooth the geometric mismatch between the two partitions. And again care must be taken to provide the necessary coupling between the two partitions to explicitly preserve the connectivity of the matched objects.

In action 116, the combined partitions are stored in a memory. Actions 106-114 has to be repeated for each partition corresponding to the partitioning scheme applied in the actions 102 and 104. In this way a new digital map is generated which is a “patch work” of corresponding partitions of the used digital map databases.

In the description given above, it has been assumed that all objects at the partitioning line, that are present in both databases could be matched by encoding a location reference from the first database and decoding and interpreting said location reference in the second database. This is however not always possible. For example, the description of a location reference could refer to a geographic phenomena that is not present in both databases. In that case, the location reference will not find a match, resulting in a part of the topology that crosses the partitioning line that could not be coupled.

Therefore, optionally the method comprises the actions 118-124. In these actions the partition of the second database is used to identify a second group of objects in the common region containing and neighboring the partitioning line in the second database. Reference numerals 308 and 310 indicate the objects identified as the second group of objects. Similarly, the objects are encoded to obtain the location references (action 120). In action 122 the location references are decoded into a data structure suitable to find the corresponding object in the first digital map database. In action 124, the data structure is interpreted and is searched for a match in the first digital map database. The location references that match will additionally be used to combine the first and second partition.

Actions 118-124 provide a second chance to find a topological connection for an object that crosses the partitioning line 304 according to the partitioning scheme. The actions perform the same function as actions 106-112 but from the opposite direction. This ensures a sufficiently high hit rate to find the topological connections between two partitions from different databases. Furthermore, by finding more objects that match between the two databases, a more accurate estimation can be made for the conversion of coordinates from one database to another database. By doing bilateral comparisons of the geometrical gap between the reference points in the coordinate reference system, the adjustment of the connection can be made more precisely.

It could happen that the first partitions comprises a road crossing the segmentation line which is not present in the second database. In that case no match can be made and the network topology for this road cannot be coupled. In that case the combined map will include the network topology of the first partition. In a more advanced embodiment, the application identifies objects along the road crossing the segmentation line that are not in the partition but present in the database. An example of such an object is the road or position of the next junction of the road outside the partition. If a match can be made, the part of the road which crosses the segmentation line and that is outside the partition, could be added to the combined digital database.

Similarly, it could happen that a less up-to-date digital map comprises a road crossing a partition line for which no match could be found in the up-to-date map. In that case, said road could be removed from the database up to for example the next junction in the part of the digital map database that is not replaced with the up-to-date part from the up-to-date digital map.

From the description given above, one skilled in the art would recognize that the method according to the invention provides a tool to test the viability or compatibility of a new partition as a replacement for an old partition prior to the actual replacement of the old partition. In that case, the combining action 114 comprises evaluating the result of the decoding action(s) 110, 112 to determine the compatibility of the content of the two databases to be combined and if the content of the databases are regarded to be compatible, replacing the content of the database corresponding to the old partition with the content of the new partition. A measure to determine the compatibility could be the percentage of selected objects that could be matched, and/or the distribution of the determined offsets in the coordinate reference system of matched objects or even the identification of a single connection that might be broken as a result of the new partition.

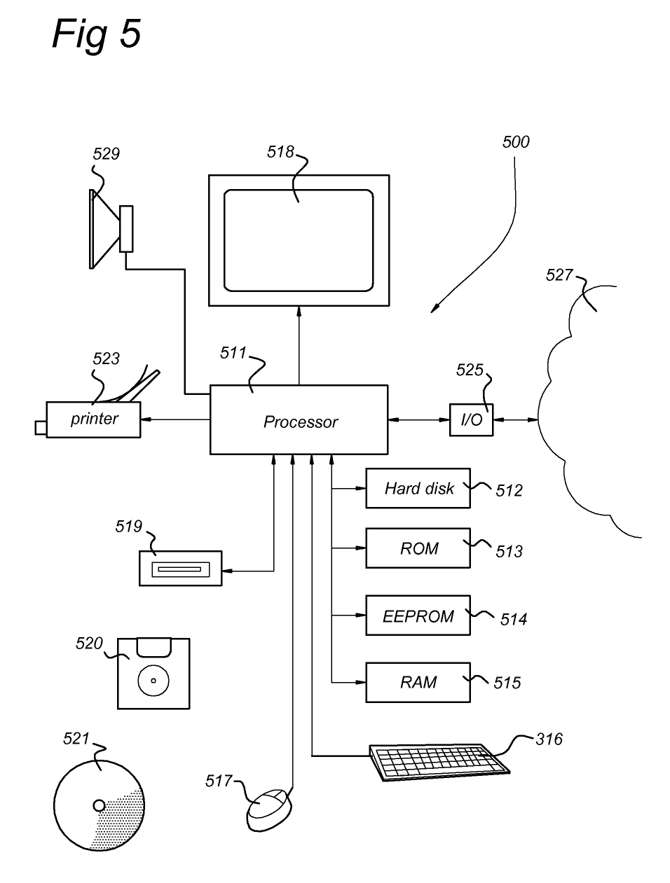

In FIG. 5, an overview is given of a computer arrangement 500 comprising a processor 511 for carrying out arithmetic operations. The processor 511 is connected to a plurality of memory components, including a hard disk 512, Read Only Memory (ROM) 513, Electrical Erasable Programmable Read Only Memory (EEPROM) 514, and Random Access Memory (RAM) 515. Not all of these memory types need necessarily be provided. Moreover, these memory components need not be located physically close to the processor 511 but may be located remote from the processor 511.

The processor 511 is also connected to means for inputting instructions, data etc. by a user, like a keyboard 516, and a mouse 517. Other input means, such as a touch screen, a track ball and/or a voice converter, known to persons skilled in the art may be provided too.

A reading unit 519 connected to the processor 511 is provided. The reading unit 519 is arranged to read data from and possibly write data on a removable data carrier or removable storage medium, like a floppy disk 520 or a CDROM 521. Other removable data carriers may be tapes, DVD, CD-R, DVD-R, memory sticks, solid state memory (SD cards, USB sticks) compact flash cards, HD DVD, blue ray, etc. as is known to persons skilled in the art.

The processor 511 may be connected to a printer 523 for printing output data on paper, as well as to a display 518, for instance, a monitor or LCD (liquid Crystal Display) screen, head up display (projected to front window), or any other type of display known to persons skilled in the art.

The processor 511 may be connected to a loudspeaker 529.

Furthermore, the processor 511 may be connected to a communication network 527, for instance, the Public Switched Telephone Network (PSTN), a Local Area Network (LAN), a Wide Area Network (WAN), Wireless LAN (WLAN), GPRS, UMTS, the Internet etc. by means of I/O means 525. The processor 511 may be arranged to communicate with other communication arrangements through the network 527.

The data carrier 520, 521 may comprise a computer program product in the form of data and instructions arranged to provide the processor with the capacity to perform a method in accordance to the invention. However, such computer program product may, alternatively, be downloaded via the telecommunication network 527.

The processor 511 may be implemented as a stand alone system, or as a plurality of parallel operating processors each arranged to carry out subtasks of a larger computer program, or as one or more main processors with several sub-processors. Parts of the functionality of the invention may even be carried out by remote processors communicating with processor 511 through the telecommunication network 527.

The components contained in the computer system of FIG. 5 are those typically found in general purpose computer systems, and are intended to represent a broad category of such computer components that are well known in the art.

Thus, the computer system of FIG. 5 can be a personal computer, workstation, minicomputer, mainframe computer, etc. The computer can also include different bus configurations, networked platforms, multi-processor platforms, etc. Various operating systems can be used including UNIX, Solaris, Linux, Windows, Macintosh OS, and other suitable operating systems.

The method described above could be performed automatically. It might happen that the neighboring partition of the “patch work” map could not be combined. For example no topological matches have been found due to too large offset between object in the coordinate reference system. In that case, the database needs some correction. In that case the method includes some verification and manual adaptation actions to enable the possibility to confirm or adapt intermediate results to obtain the best result.

The presented method is very to include a high quality map into a map with less quality in the corresponding region. The area of high quality map could be fully encompassed by the area of the lower quality map. In that case, the topological connections reaching the edge of the high quality map could be used as references. Furthermore, objects within a predetermined distance from the edge of the high quality map could be selected to generate a location reference. By matching the location references in the low quality map by means of the method according to the invention, the corresponding area of the high quality map can be determined in the low quality map. The location references which matches in the low quality database could be used to determine the area in the low quality map corresponding to the high quality map. Then the determined area in the low quality map is removed from the low quality database and substituted by the content of the high quality map. The positions in the coordinate references system of the objects in the combined database could be corrected according to one of the methods described above. In this embodiment, the area of the high quality database, which is only one partition, defines the partitioning of the low quality database.

The method according to the invention is very suitable to run in a data production center as part of a digital map database production and conflation process of map production companies.

The method according to the invention is also very suitable to be implemented in navigation systems comprising a digital map database. Such navigation systems may be build for a vehicle, (e.g. car, van, truck, motorbike) or mobile device (personal digital assistant (PDA), mobile phone, handheld computer, or a personal navigation device). In that case, the navigation system comprises a computer implemented system with parts as shown in FIG. 5. A computer readable memory carries a first digital map. The computer implemented system comprises further an input device for retrieving a second digital map. The second digital map could be retrieved from a removable storage medium or other removable data carrier. In that case, the system comprises a reading unit 519 for reading the second digital map from the memory device. The second digital map could also be retrieved via a communication network 527 by means of I/O means 525 from a transmission medium. Next to the second digital map, also the applied segmentation and location reference encoder and decoder have to be retrieved. The segmentation identifies the partitioning line in the first database and the partition of the first database to be replaced by the corresponding content of the second database. The location reference encoder and/or decoder are needed to generate the location references from the second database and the location reference decoder is needed to match a location reference on the second database. The method according to the invention enables a user to replace/extend on the fly parts of an existing digital map database in the navigation system with new or more accurate/detailed parts from another external digital map database, which may be retrieved from another digital map supplier. The method of the invention provides a solution to update a part of a digital map generated by a first digital map supplier with a corresponding part of another digital map generated by a second digital map supplier or with a corresponding part of a digital map generated by the first digital map supplier at a later time. The method could be performed by a map supplier at a processor centre but also in a navigation system.

The foregoing detailed description of the invention has been presented for purposes of illustration and description. It is not intended to be exhaustive or to limit the invention to the precise form disclosed, and obviously many modifications and variations are possible in light of the above teaching. The described embodiments were chosen in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

1. Method of combining a first partition from a first digital map database and a second partition from a second digital map database, the first and second digital map database being associated with a coordinate reference system and, the first and second partition including an interaction with each other in a common region in the first and second digital map database, the method comprising:
identifying a first group of objects in said first partition from said first digital map database, wherein each object comprises a position within said common region;
encoding the objects of the first group with a first group of location references;
decoding the first group of location references on the second partition from the second digital map database;
identifying the location references of the first group that could successfully decode on the second partition to determine topological connections; and
combining the first partition with the second partition in the second map database in dependence of the location references associated with the topological connections.

2. Method according to claim 1, wherein an object corresponds to one of the group consisting of road, ferry, railway, walkway, public transport crossing the border of a partition, city, county, state, country, region, road segment, junction, building, landmark.

3. Method according to claim 1, wherein the method further comprises:
identifying a second group of objects in said second partition from said second digital map database, wherein each object comprises a position within said common region;
encoding the objects of the second group to obtain a second group of location references;
decoding the second group of location references on the first partition;
identifying the location references of the second group that could successfully decode on the first partition to determine additional topological connections; and,
combining the first partition and the second partition in dependence of the location references associated with the topological connections and additional topological connections.

4. Method according to claim 1, where the interaction between the first partition from the first digital map database and the second partition from the second digital map database corresponds to a spatial relationship selected from the group consisting of:
Touches
Within-Overlaps
Crosses
Intersects
Equals,
Connects with, -Disjoint.

5. Method according to claim 1, wherein the combining comprises:
calculating offsets in position in the coordinate reference system of the positions in the first digital map and the second digital map of the objects associated with the topological connections;
determining a positional adjustment of objects of at least one of the first and second digital map in dependence of the offsets; and
combining the first and second partition in dependence of the positional adjustment to obtain a combined digital map.

6. Method according to claim 5, wherein the determining of a positional adjustment comprises:
averaging the offsets in position in the coordinate reference system of the positions in the first digital map and the second digital map of the objects associated with the topological connections to obtain a translation vector; and
obtaining the combined digital map by translating the position of the first partition or second partition over the translation vector.

7. Method according to claim 1 wherein the combining comprises:
calculating an average position in the coordinate reference system from the position of an object associated with a topological connection in the first digital map and the second digital map; and applying the average position to the object associated with the topological connection to obtain a combined digital map.

8. Method according to claim 1, wherein the combining comprises:
performing rubber sheeting by way of the objects associated with the topological connections to obtain a combined digital map.

9. Method according to claim 1, wherein a step in the combining comprises:
evaluating the result of the decoding to determine the compatibility of the two databases.

10. Method of generating an enhanced digital map database, the method comprising:
segmenting a first and second digital map database into first and second partitions in dependence of a partitioning scheme;
generating a set of interacting partitions from the first and second digital map; and
applying the method according to claim 1 to combine the set of interacting partitions to generate the enhanced digital map database.

11. Method according to claim 10, wherein the generating of the set of interacting partitions comprises selecting from similar partitions of the first and second database the partition having the best characteristic, wherein a characteristic is at least one selected from the group including quality, currentness, absolute position accuracy, relative position accuracy, completeness, and included features.

12. Method according to claim 10, wherein the partitioning scheme is based on at least one taken from the group including: arbitrary, regular grid, political, town boundary, municipal boundary, local authority boundary, district boundary, county limit, federal state, country, or any other suitable segmentation rule.

13. A computer implemented system for combining a first partition from a first digital map database and a second partition from a second digital map database, the first and second digital map database being associated with a coordinate reference system and the first and second partition including an interaction with each other in a common region in the first and second digital map database, the system comprising:
an input device;
a processor readable storage medium;
a processor in communication with said input device and said processor readable storage medium; and
an output device in communication with a display unit, said processor readable storage medium storing code to program said processor to perform at least,
identifying a first group of objects in said first partition from said first digital map database, wherein each object comprises a position within said common region;
encoding the objects of the first group with a first group of location references;
decoding the first group of location references on the second partition from the second digital map database;
identifying the location references of the first group that could successfully decode on the second partition to determine topological connections; and
combining the first partition with the second partition in the second map database in dependence of the location references associated with the topological connections.

14. A computer implemented system according to claim 13, wherein the processor readable storage medium carries the first digital map database, the input device is arranged to retrieve the second digital map database from a transmission medium, and the processor is arranged to store the combination of the partitions on the processor readable storage medium.

15. A computer program which, when loaded on a computer arrangement, is arranged to perform the methods according to claim 1.

16. A processor readable medium carrying a computer program which, when loaded on a computer arrangement, is arranged to perform the methods according to claim 1.

17. A computer readable medium including program segments for, when executed on a computer arrangement, causing the computer arrangement to implement the method of claim 1.
